(19) United States
(12) Patent Application Publication
(10) Pub. No.: US 2022/0081592 A1
(43) Pub. Date: Mar. 17, 2022

(54) DEVICE AND METHOD FOR PRODUCING ADHESIVE TAPES WITH RADIATION-INDUCED POLYMERISATION OF THE ADHESIVE MATERIAL

(71) Applicant: ADHESIVE POYLMERS INTERNATIONAL GMBH & CO. KG, Nördlingen (DE)

(72) Inventors: Ulrich GERLINGER, Oettingen in Bayern (DE); Renate SCHILLER, Meitingen (DE)

(73) Assignee: ADHESIVE POYLMERS INTERNATIONAL GMBH & CO. KG, Nördlingen (DE)

(21) Appl. No.: 17/425,503

(22) PCT Filed: Jan. 23, 2020
(86) PCT No.: PCT/EP2020/051568

§ 371 Date: Jul. 23, 2021

(30) Foreign Application Priority Data
Jan. 23, 2019 (DE) 102019101582.0

(51) Int. Cl. C09J 7/38; C09J 133/10; C09J 7/24

(52) U.S. Cl. CPC C09J 7/381; C09J 7/243; C09J 133/10

(57) ABSTRACT

A method for the production of pressure-sensitive adhesive tapes includes providing a web-shaped substrate, providing a pressure-sensitive adhesive composition and/or a precursor for a pressure-sensitive adhesive composition, wherein the pressure-sensitive adhesive composition and/or the precursor for a pressure-sensitive adhesive composition comprising at least one polymerisable (meth)acrylate monomer and/or (meth)acrylate oligomer and/or (meth)acrylate polymer and at least one polymerisation initiator and having a solvent content of <5% by weight, based on the total mass of the pressure-sensitive adhesive composition, applying the pressure-sensitive adhesive composition and/or its precursor to one or both sides of at least sections of the web-shaped substrate, transporting a web-shaped substrate to which the pressure-sensitive adhesive composition and/or its precursor has been applied along a predetermined transport path, wherein the transport path extending at least in sections in the region of influence of an emitter for electromagnetic radiation, electrons or accelerated ions, electrons or accelerated ions, activation of the polymerisation initiator by acting upon with electromagnetic radiation, electrons or accelerated ions during the transport of the web-shaped substrate along the predetermined transport path, and polymerisation of the pressure-sensitive adhesive composition and/or of the precursor for a pressure-sensitive adhesive composition on the web-shaped substrate during its transport. Furthermore, an apparatus for carrying out this method and a pressure-sensitive adhesive tape produced according to this method are disclosed.

The present invention relates to a method for producing pressure-sensitive adhesive tapes according to the preamble of claim 1. Furthermore, the invention relates to an apparatus for producing pressure-sensitive adhesive tapes according to the preamble of claim 11 and to a pressure-sensitive adhesive tape according to the preamble of claim 14.

Various methods for applying pressure-sensitive adhesive compositions to web-shaped substrates are known from the prior art. The aim of these methods is the production of pressure-sensitive adhesive tapes. The tapes can be coated with pressure-sensitive adhesive composition on one or both sides.

A number of pressure-sensitive adhesive tapes are known from the prior art. These can be single-sided or double-sided pressure-sensitive adhesive tapes. In order to meet the increased requirements with regard to environmental compatibility and the efficiency of the manufacturing process of such pressure-sensitive adhesive tapes, processes have increasingly been described in the past in which the pressure-sensitive adhesive compositions are handled without solvents.

However, the handling of such solvent-free pressure-sensitive adhesive compositions places special demands on the equipment/plants with which these pressure-sensitive adhesive compositions are handled. The handling of pressure-sensitive adhesive compositions with high melt viscosities is particularly problematic. In particular, with such pressure-sensitive adhesive compositions it is necessary to maintain the high temperatures required for processing over the entire duration of processing. The handling or drying of both solvent-based acrylic pressure-sensitive adhesive compositions and water-based dispersion acrylic pressure-sensitive adhesive compositions is particularly problematic. The particular difficulty lies—due to the input of most of the drying energy via the open adhesive surface—in evaporating the solvent(s) or water (possibly with the application of a high primary energy input) during the drying process of higher and higher application weights without the formation of a skin on the surface of the pressure-sensitive adhesive that impedes evaporation. Otherwise, there is too much residual solvent content or too much residual moisture in the pressure-sensitive adhesive, or the pressure-sensitive adhesive is bubbly and/or does not have a smooth, closed surface. In practice, this can only be achieved by gentle drying, which in turn can only be achieved by slow drying/process speeds and/or very long drying channels. The drying of very high application weights of the above-mentioned acrylate pressure-sensitive adhesive compositions is not at all possible with conventional processes and such pressure-sensitive adhesive tapes have to be produced by doubling up several pressure-sensitive adhesive layers. Therefore, there is a need to provide a method for the production of pressure-sensitive adhesive tapes that allows the handling of solvent-free pressure-sensitive adhesive compositions and at the same time enables a particularly easy handling of the pressure-sensitive adhesive compositions, preferably at room temperature, as well as an efficient, i.e. fast and qualitatively flawless homogeneous film formation.

Furthermore, there is a need for an apparatus for the production of pressure-sensitive adhesive tapes, which also enables the handling of solvent-free pressure-sensitive adhesive composition.

In addition, there is a need for pressure sensitive tapes that have a solvent-free pressure sensitive adhesive composition.

These objects are solved by the subject matters of independent claims 1, 11 and 14. Preferred embodiments are the subject matters of the dependent claims.

A similar object is also the basis of the publication DE 10 2004 044 084 A1. According to this publication, the cross-linking of the pressure-sensitive adhesive composition is delayed by handling two reactive components separately from each other and mixing them together only at a late stage so that they react to form the desired pressure-sensitive adhesive composition. The mixing of the components is delayed until immediately before the coating process. This is to ensure that the cross-linking of the pressure-sensitive adhesive composition and associated curing/difficulty in handling is delayed. Thus, the pressure-sensitive adhesive composition is still easy to handle until immediately before application to the web-shaped substrate, despite the start of component mixing and the resulting chemical reaction of the contained reactive components. During the coating process and/or after application to the web to be coated, the reactive components of the multi-component mixture react to form the desired pressure-sensitive adhesive compositions with the specified adhesive properties.

The method for producing pressure-sensitive adhesive tapes according to the invention differs from this process known from the prior art in that the polymerisation takes place by electromagnetic radiation, electrons or accelerated ions after the pressure-sensitive adhesive composition and/or its precursors have been applied to sections of a web-shaped substrate.

Preferably, such a pressure-sensitive adhesive tape is a technical adhesive tape for use in the construction industry.

Even if at least one polymerisation step and preferably also a cross-linking of the polymers produced takes place on the web-shaped substrate and thus the applied mass differs from the pressure-sensitive adhesive compositions on the product, the applied mass is also referred to as pressure-sensitive adhesive compositions and/or its precursor, since it could already have adhesive properties. With regard to all process steps that take place before the process step of the acting upon with electromagnetic radiation, electrons or accelerated ions described below, pressure-sensitive adhesive composition and precursor of a pressure-sensitive adhesive composition are therefore to be understood synonymously, unless this is expressly described otherwise. After the acting upon with electromagnetic radiation, electrons or accelerated ions and the chemical reaction induced thereby, a chemically modified (product) pressure-sensitive adhesive composition is present, which differs from the precursor at the molecular level but also in its physical properties. This layer with adhesive properties, which is then fixed to a carrier, is also referred to as a pressure-sensitive adhesive composition.

Accordingly, the method according to the invention is characterised by the steps: providing a web-shaped substrate, providing a polymerisable pressure-sensitive adhesive composition and/or a precursor for a pressure-sensitive adhesive composition, wherein the pressure-sensitive adhesive composition and/or the precursor for a pressure-sensitive adhesive composition containing at least one polymerisable (meth)acrylate monomer and/or (meth-)acrylate oligomer and at least one polymerisation initiator and having a solvent content of <5% by weight, based on the total mass of the pressure-sensitive adhesive composition, applying the pressure-sensitive adhesive composition or its precursor on one or both sides to at least sections of the web-shaped substrate, transporting a web-shaped substrate to which the pressure-sensitive adhesive composition or precursors thereof have been applied along a predetermined transport path, wherein the transport path extending at least in sections in the region of influence of an emitter for electromagnetic radiation, electrons or accelerated ions, activating the polymerisation initiator by acting upon with electromagnetic radiation, electrons or accelerated ions along the transport path, and chemically polymerising the pressure-sensitive adhesive composition.

Further preferred it is provided that the polymerisable pressure sensitive adhesive composition or its precursor is optionally also crosslinkable.

Preferably, the polymerisable pressure sensitive adhesive composition or its precursors do not comprise elastomers or rubbers as starting materials.

In a preferred variant, it is provided that the pressure-sensitive adhesive composition is produced from a solvent-free mixture by free-radical polymerisation.

Alternatively or additionally, it is preferred that the polymerisation initiator can be activated by electromagnetic radiation.

Furthermore, it is independently preferred that the pressure-sensitive adhesive composition or its precursor comprises monofunctional and/or polyfunctional (meth)acrylate monomers, at least one initiator (e.g. a photoinitiator), and optionally crosslinkers, resins and/or fillers.

In a preferred embodiment, the pressure-sensitive adhesive composition and/or its precursor is solvent-free.

In the case of double-sided application of the pressure-sensitive adhesive composition or its precursor, this can be done in one step or in two separate steps.

Cross-linking is understood as a reaction in which a plurality of individual macromolecules are linked to form a three-dimensional network. This (cross)linking can take place in parallel with polymerisation and thus occur during the assembly/elongation of the macromolecules or subsequently by (cross)linking of already existing polymers. Preferably, neither electromagnetic radiation, nor electrons or accelerated ions are needed for the cross-linking in the present method.

The web-shaped substrate can be a permanent carrier for the pressure-sensitive adhesive composition and thus the pressure-sensitive adhesive tape to be produced. Alternatively, the web substrate could also be a release liner for the pressure-sensitive adhesive tape. This release liner is not part of the pressure-sensitive adhesive tape as it is used, but merely prevents the pressure-sensitive adhesive composition of different layers from sticking together when they are wound up into a roll. It is thus possible to produce single-sided and double-sided adhesive tapes with a carrier or scrim using the process according to the invention. Single- and double-sided adhesive tapes are preferably applied to the release liner—in particular from medium application weights—and then any carrier of single- or double-sided adhesive tapes is laminated onto the ready-polymerised pressure-sensitive adhesive by pressure and, if necessary, temperature support.

A release liner as described above is not absolutely necessary. In a preferred method variant, a web-shaped substrate is used, which has two opposing surfaces that have different adhesive properties with respect to the pressure-sensitive adhesive composition. These different properties are achieved by surface treatment (e.g. corona, plasma) or by a release or primer coating. One of these surfaces has stronger adhesion to the pressure-sensitive adhesive composition than the opposite surface. In a further preferred method variant, a crosslinker is added to the pressure-sensitive adhesive composition, which also forms bonds with functional groups of the web-shaped substrate during the crosslinking process. This is in particular preferred if the web-shaped substrate is subjected to a surface treatment, e.g. corona, plasma, flame or fluorination pretreatment, (immediately) prior to application of the pressure-sensitive adhesive composition, wherein such a treatment can of course also be provided if the pressure-sensitive adhesive composition does not comprise a crosslinker. Thus, when a rolled pressure-sensitive adhesive tape is unrolled, the pressure-sensitive adhesive composition remains exclusively on the side of the web-shaped substrate which has the stronger adhesion with respect to the pressure-sensitive adhesive composition. However, it easily detaches from the side of the web-shaped substrate that has the lower adhesion with regard to the pressure-sensitive adhesive composition. This makes a release liner unnecessary.

When the pressure sensitive adhesive composition consists from multiple layers, the different layers may have different properties. For example, they may differ in properties selected from a group comprising polymer chain length, adhesive force, coat weight, degree of crosslinking, material composition, initiator molecules, colour and others. The different layers of pressure sensitive adhesive composition may have been prepared according to different formulations by the method according to the invention or from a combination of the method according to the invention and other common methods for the preparation of pressure sensitive adhesives.

The initiator is, for example, a photoinitiator. However, other specifically activatable initiator molecules could also be used. Preferably, these are radical initiator molecules. The initiator is preferably selected from a group comprising benzophenones, benzil derivatives, benzoin derivatives, dialkoxyacetophenones, phosphine oxides, phosphinic acid esters and hydroxyalkylphenones. Preferably, the initiator(s) is/are added to the pressure-sensitive adhesive composition in a proportion of 0-10% by weight (weight percent), preferably 0.01-5% by weight, particularly preferably 0.05-2% by weight, based on the mass of the total pressure-sensitive adhesive composition. In the following, unless explicitly stated otherwise, all percentages are to be understood as weight percentages (weight. %) based on the mass of the entire pressure-sensitive adhesive composition.

Further preferred it is provided that the crosslinker is selected from a group comprising aziridines, polycarbodiimides, epoxides, amino resins, peroxides, triazines, isocyanates, organofunctional silanes, propylenimines, ethylenimines, metal acid esters, metal chelates and metal salts. The crosslinker(s) is/are preferably added to the pressure-sensitive adhesive composition in a proportion of 0-10% by weight, preferably 0-5% by weight, particularly preferably 0.01-2% by weight, based on the mass of the total pressure-sensitive adhesive composition.

In a further preferred variant of the method, at least one resin is selected from a group comprising hydrocarbon resins and unsaturated polyester resins, in particular terpene resins, terpene phenolic resins, acrylate resins, urethane resins, melamine resins and natural resins. Preferably, the resin(s) is/are added to the pressure-sensitive adhesive composition in a proportion of up to 50% by weight, preferably up to 30% by weight, particularly preferably up to 20% by weight, based on the mass of the total pressure-sensitive adhesive composition.

In another alternative variation of the method, a resin-free pressure-sensitive adhesive composition is provided.

In a preferred variant of the method, the polymerisation takes place in a reaction chamber which is filled with one or more inert media, e.g. an inert gas. Such a reaction chamber is in particular preferably formed by a housing which is preferably rigid at least in sections, which can be closed on all sides at least in the operating state, but which has at least one inlet region and one outlet region through which the web-shaped substrate, the pressure-sensitive adhesive composition, optionally auxiliary materials and/or the inert medium can be guided into the reaction chamber or out of it. Preferably, these inlet or outlet regions are designed in such a way that the outflow of the inert medium from the reaction chamber is prevented or at least reduced during the passage of the inlet or outlet region through the other material(s). Corresponding means are known from the prior art. For example, it could be a sluice, an overpressure area or similar means. By conducting the reaction in a reaction chamber filled with at least one inert medium, undesirable side reactions can be at least largely avoided. As shown in detail below, the inert medium may also serve to set and/or maintain a desired temperature range in the reaction chamber. In particular, inert gases such as noble gases, preferably argon and/or helium, carbon dioxide, nitrogen and/or mixtures thereof are preferred as the inert medium.

In a further preferred variant, the polymerisation is carried out in a reaction chamber which has a flexible boundary at least in sections, preferably at least along a plane formed by the web-shaped substrate or a plane parallel thereto. Such a flexible boundary could be, for example, a single- or multi-layer film, membrane or the like.

Preferably, such a reaction chamber has a flexible boundary on at least 2, preferably at least 3, further preferably at least 4 and particularly preferably at least 5 sides. For example, it is conceivable that a first flexible boundary is arranged on one side of the web-shaped substrate or is formed by the latter and a further flexible boundary is arranged on the side of the web-shaped substrate opposite the first flexible boundary or is formed by the latter itself. In addition or alternatively thereto, it is conceivable that a first flexible boundary is arranged on one side of the web-shaped substrate or is formed by the latter and its at least one broadside end region extending along the longitudinal or transport direction is at least in sections reshaped in the direction of a further flexible or rigid boundary in such a way that along this broadside the reaction chamber is at least in sections closed by the first flexible boundary. Of course, in a preferred variant, both broadside end regions of the first flexible boundary can also be reshaped towards a further flexible or rigid boundary in such a way that along both broad sides the reaction chamber is closed at least in sections by the first flexible boundary.

Preferably, a cleanroom having a flexible boundary also comprises a side having an opening through which an inert fluid can be introduced into the cleanroom.

In particular, it is preferred that the first flexible boundary is formed by the web-shaped substrate and a second flexible boundary is formed by a foil and/or membrane extending at least in sections parallel to the web-shaped substrate, wherein the broadside end portions of the first and second flexible boundaries are connected to each other in such a way that a cross-section perpendicular to the transport direction of the web-shaped substrate has a circumference completely closed by the flexible boundaries. For example, the broadside end portions of the first flexible boundary and the second flexible boundary could be pressed together and/or glued together.

It is also conceivable that a further boundary of the reaction chamber is formed by reducing an intermediate space between the first flexible boundary or the web-shaped substrate and the second flexible boundary in a region of the reaction chamber at the end along the transport direction in such a way that the passage of a non-inert medium is prevented. Preferably, this is done by deflecting the first flexible boundary or the web-shaped substrate and the second flexible boundary. Preferably, the first flexible boundary or the web-shaped substrate and the second flexible boundary are guided together over a roller extending in the width direction. Further preferably, the first flexible boundary or the web-shaped substrate and the second flexible boundary are wound together or the flexible boundaries are alternatively unwound. This is particularly preferred in a method variant in which one flexible limitation is formed by the web-shaped substrate and another flexible limitation is formed by a release layer. This has the advantage that the desired (intermediate) product is produced directly when winding up into a (jumbo) roll (if necessary after cutting off the side areas).

Should the reaction chamber be closed on the broadside by forming and/or gluing the broadside end regions, it is advantageous to also deflect or wind up these broadside regions and only separate them in a later process step, preferably after complete completion of the reaction, for example by cutting them off the resulting roll. If the reaction is already completed before the deflection over a roll extending in the width direction, it would also be conceivable to separate the broadside regions during the transport of the web-shaped substrate, for example by introducing one or more separating devices into the transport path. For example, the web-shaped substrate could be guided past rigid or movable knives or saws that project at least in sections into the transport path.

The formation of one flexible boundary by the web-shaped substrate and another flexible boundary by a release liner is a preferred variant independent of the above-mentioned method.

In another preferred variant, the flexible boundary is not a release liner of the pressure-sensitive adhesive tape but a film that is removed after the polymerisation reaction and before converting.

Advantageously, the reaction chamber is designed such that the first flexible boundary and the second flexible boundary contact the pressure sensitive adhesive composition. This ensures that the volume between the first boundary and the second flexible boundary is minimised. This has the advantage that the volume to be filled with the inert medium and thus the inert medium consumption is minimal. In particular, it is preferred that in the region of activation of the polymerisation initiator, the volume between the first flexible boundary and the second flexible boundary is completely occupied by the pressure-sensitive adhesive composition and thus no additional inert medium is required to maintain inert conditions. This represents a particularly preferred variant. In an alternative, also preferred variant, the penetration of non-inert medium such as ambient air is prevented by generating a preferably low overpressure relative to the environment by processes associated with the polymerisation. This could be achieved, for example, by evaporation of solvent or monomers by the heat of reaction. It would also be conceivable to separate gaseous components during polymerisation.

In order to prevent ambient air or other non-inert substances from flowing into the reaction chamber, it is conceivable that a pre-treatment volume adjoins the reaction chamber upstream of its end region. This could be a volume which contains an inert medium and into which the first flexible boundary, the second flexible boundary and the pressure-sensitive adhesive composition are introduced. These are preferably arranged in this pre-treatment volume in such a way that a reaction chamber as described above is created, which is formed on one side of the pressure-sensitive adhesive composition by the first flexible boundary and also on the opposite side of the pressure-sensitive adhesive composition by the second flexible boundary.

Preferably, this is done in such a way that a first flexible boundary is guided into the pretreatment volume and the pressure-sensitive adhesive composition (and, if applicable, if the first flexible boundary does not also form the web-shaped substrate, also a web-shaped substrate) is applied to it, preferably without bubbles. It may be advantageous to spread the pressure sensitive adhesive composition. Optionally, excess pressure-sensitive adhesive composition is removed again so that a predetermined layer thickness can be ensured. Once the pressure-sensitive adhesive composition has been applied in the predetermined layer thickness, it is preferably acted upon by the second flexible boundary. This is preferably done by a roller system which places the second flexible boundary on the pressure-sensitive adhesive composition or presses it against it. This enables particularly small volumes of the volume formed between the first and second flexible boundary. Optionally, it could be provided that a flow of an inert medium is passed over the pressure-sensitive adhesive composition before the second flexible boundary is applied to the pressure-sensitive adhesive composition, in order to remove any remaining residues of non-inert medium. Preferably it is provided, that the source of the inert medium is arranged in the pretreatment volume between a feed of the first flexible boundary and a feed of the second flexible boundary. This ensures that any non-inert medium possibly present between the first flexible boundary and the second flexible boundary can be discharged to the outside with the inert medium flow and thus does not enter the reaction chamber.

In particular, it is preferred that at least one flexible boundary is at least partially permeable, at least in sections, to electromagnetic radiation, electrons or accelerated ions. In particular, it is preferred that this flexible boundary is at least partially permeable, at least in sections, to the radiation that is used to activate the polymerisation initiator. In this way, it can be achieved that the source for the radiation used to activate the polymerisation initiator can be arranged outside the (inert) reaction chamber and is thus accessible easily and preferably without having to open the reaction chamber. Thus, maintenance work is simplified, accelerated and also the recommissioning is accelerated. Downtimes can be reduced.

A variant in which both the first flexible boundary and the second flexible boundary are at least partially permeable, at least in sections, to the radiation used to activate the polymerisation initiator is particularly preferred. This allows the pressure-sensitive adhesive composition to be exposed to the radiation used to activate the polymerisation initiator from at least two sides. This enables the production of pressure-sensitive adhesive tapes in which the web-shaped substrate is acted upon with pressure-sensitive adhesive composition on both sides in a single work step. In addition, gradients in the degree of polymerisation and/or crosslinking of the pressure-sensitive adhesive composition can be avoided or at least reduced even if the web-shaped substrate is only acted upon with pressure-sensitive adhesive composition on one side. Thus, a uniform degree of polymerisation and/or cross-linking and a controlled product quality with a constant adhesive property over the entire thickness of the pressure-sensitive adhesive layer can be ensured.

In a further preferred method variant, the pressure-sensitive adhesive composition is applied to the web-shaped substrate at a temperature between 10 and 30° C., preferably between 15 and 25° C., particularly preferably at room temperature of about 20° C. Since waste heat is generated during the polymerisation reaction or the crosslinking reaction, it may be necessary to dissipate waste heat. This could be done passively by cool ambient air, for example. Alternatively or supplementarily, this could be realised, for example, by actively cooled transport rollers. Alternatively or supplementary thereto, it would also be possible to actively guide a cooling medium along above and/or below the web-shaped substrate or the pressure-sensitive adhesive composition. This can be done, for example, longitudinally or transversely to the transport direction of the pressure-sensitive adhesive tape. Preferably, cooling is effected by exposure to a gas atmosphere. In this case, it is possible that the gas flow is directed over the pressure-sensitive adhesive composition in the transport direction or in the opposite direction to the transport direction. Preferably, the cooling medium is applied against the direction of transport. This has the advantage that cool cooling medium already contacts cooler areas of the pressure-sensitive adhesive tape. Thus, the heating of the cooling medium is kept within limits, so that its effect can be guaranteed over a relatively large area. Alternatively or in addition, in a preferred embodiment, the substrate can be acted upon with the cooling medium on one or both sides over the entire length of the transport channel by means of nozzles at a distance of 2-100 cm, preferably 5-50 cm. Preferably, the cooling medium is extracted. This can be used for recooling. The extraction of the cooling medium can take place at any location in the reaction chamber, but preferably the extraction takes place either laterally to the nozzles or preferably between the nozzles. The nozzles are preferably designed in such a way that the best possible cooling performance is achieved by a high heat transfer. Preferably, inert gases such as noble gases, in this case preferably argon or helium, are used as cooling medium. Carbon dioxide or nitrogen, for example, could also be used as a much more cost-effective alternative. Mixtures of all the above-mentioned gases are also possible.

Further preferred is a method in which the pressure-sensitive adhesive composition is applied to the web-shaped substrate with an application weight of 1-5000 g/m2, preferably 5-4000 g/m2. These application weights have proven to be particularly advantageous, as they can guarantee the adhesive forces usually required in the construction industry. At lower application weights, the pressure-sensitive adhesive layer is preferably thin enough so that it can be completely penetrated by the radiation leading to polymerisation (preferably also when only one side is exposed to radiation) and allows polymerisation to occur uniformly over the entire thickness of the pressure-sensitive adhesive layer without creating a gradient. For higher application weights of more than 1000 g/m2, preferably more than 1500 g/m2, in particular preferably more than 2000 g/m2, the use of higher light intensities and/or a slower coating speed and/or irradiation from several directions is preferred in order to prevent the formation of gradients and/or the development of different properties on both sides.

As already mentioned above, the method is preferably carried out in a range between 10 and 30° C. In order to maintain this temperature range, the removal of reaction heat from the chemical reaction of the polymerisation of the pressure sensitive adhesive is advantageous. This can be done passively or by active cooling. Even if the reaction is carried out outside the temperature range mentioned above, the removal of waste heat may be necessary, for example to avoid decomposition reactions. In a preferred method variant, the heat of reaction from the chemical reaction of the polymerisation of the pressure-sensitive adhesive composition is therefore dissipated. Preferably, this is done by means of an inert gas stream. Such a cool inert gas flow can be directed above and/or below the pressure-sensitive adhesive tape or its precursors as described above. It is advisable to direct the inert gas flow along the side on which the pressure-sensitive adhesive composition is arranged. Alternatively or in addition to this, the underside of the web-shaped substrate can of course also be acted upon with the inert gas flow. Preferably, the inert gas flow is directed tangentially to the respective surface. Preferably, the flow velocity is between 1 and 120 m/s, particularly preferably between 2.5 and 80 m/s, further preferably between 5 and 60 m/s.

In a preferred embodiment, it is provided that at least one transport roller, preferably several transport rollers, are cooled by a cooling medium. The cooling medium can be a gas or a liquid. Preferably, the cooling medium is an inert gas which is passed over the transport rollers to be cooled. Alternatively or additionally, a fluid, preferably liquid cooling medium, further preferably water, can be passed through the transport rollers to be cooled.

Alternatively, or in addition to this, cooling can also be carried out by contact cooling, by cooling the bottom of the transport channel on which the web-shaped substrate runs during transport.

By means of the method described above, almost all commonly used web-shaped substrates can be coated. Preferably, however, the web-shaped substrate is selected from a group comprising coated and uncoated, single-layer or multilayer plastic films, preferably PE, PP, EVA, a mixture of PE and PP, PO and EVA, PET, PU, TPU, TPE, PA, PVC, PI films or film (metal) laminates, coated and uncoated papers, nonwovens, fabrics, (siliconised) metal films, papers siliconised on one or both sides and plastic films siliconised on one or both sides, preferably PE, PP or PET films. These materials have shown that they are particularly well suited to meet the durability, strength and mechanical and chemical resilience requirements demanded in the construction industry, as well as to withstand the radiation exposure that occurs during radiation-induced polymerisation. If a load-bearing capacity beyond this is desired, the pressure-sensitive adhesive tape can optionally contain additional fibres, scrims, knitted fabrics and/or woven fabrics, which are preferably selected from a group comprising cotton fibres, cellulose fibres, protein fibres, plastic fibres, glass fibres, carbon fibres and metal fibres.

Such a reinforcement can be integrated into the web-shaped substrate or connected to the web-shaped substrate. The former is conceivable, for example, in the case of web-shaped substrates made of PO or PET or aluminium, in which, for example, a scrim or similar is embedded in the web-shaped substrate, for example by means of PO melt. However, the (reinforcement) layer is preferably designed as a separate layer. This can be realised particularly easily if this layer is embedded in the adhesive. This could be realised, for example, by bringing this layer into contact with the web-shaped substrate (for example, depositing it thereon) and then fixing it thereon by the subsequently applied pressure-sensitive adhesive composition, or by bringing this layer into contact with the polymerised pressure-sensitive adhesive composition and fixing the web-shaped substrate or the release liner thereon. Another possibility for applying such a layer or for applying a layer additional thereto is that the pressure-sensitive adhesive composition is first applied to the web-shaped substrate and then a (reinforcing) layer is applied thereon. Depending on the viscosity of the pressure-sensitive adhesive composition (or its precursor), this layer could optionally at least partially sink into the pressure-sensitive adhesive composition and thus be fixed and/or enclosed by the latter. This could be done, for example, by feeding the reinforcing layer at a predetermined angle and a predetermined tensile stress to the web-shaped substrate provided with pressure-sensitive adhesive composition. It would also be conceivable to apply a pressure-sensitive adhesive composition to the web-shaped substrate, to apply the (reinforcing) layer thereon and to apply another layer of pressure-sensitive adhesive composition to this layer.

The method has proven to be particularly advantageous when using (meth-)acrylate-based pressure-sensitive adhesive compositions. Preferably, therefore, the pressure-sensitive adhesive composition comprises 50-99.9% by weight of (meth)acrylate monomers. As already mentioned above, the weight percentages refer to the entire pressure-sensitive adhesive composition. As (meth)acrylate monomers 50-99.9% by weight of at least one monofunctional (meth-)acrylic acid ester, 0-20% by weight of at least one vinyl carboxylic acid and 0-20% by weight of at least one polyfunctional (meth-)acrylic acid ester are used.

Fillers can also be added to the pressure-sensitive adhesive composition. These are preferably added in a proportion of 0-40% by weight based on the total pressure-sensitive adhesive composition. Preferably, these fillers are selected from a group comprising glass fibres, plastic fibres, hollow microspheres, silicas, colour pigments and flame retardants.

Preferably, the pressure-sensitive adhesive composition is applied to the web-shaped substrate with an application weight of 70-300 g/m2, in particular preferably 150-270 g/m². These application weights enable for such a pressure-sensitive adhesive tape an application of wet the often rough surfaces (in particular in applications in the construction industry) particularly well and quickly and thus to achieve great initial adhesion and fast final adhesion.

The pressure-sensitive adhesive tape produced according to the method described above preferably has an initial adhesion according to FTM 9 to steel of at least 6 N/cm, preferably ≥8 N/cm, particularly preferably ≥9 N/cm, in particular preferably ≥10 N/cm. Such a high initial adhesion is preferred, since it enables excellent bonds between the pressure-sensitive adhesive tape and the joining partner connected thereto, both under the conditions defined in FTM 9 and in use, for example in the construction industry. Thus, the immediate use and loading of the bond is possible.

The pressure-sensitive adhesive tape produced according to the method described above preferably has an adhesive strength on steel according to DIN EN 1939 of at least 6 N/cm, preferably ≥7 N/cm, particularly preferably ≥8 N/cm. This adhesive strength ensures excellent bonds between the pressure-sensitive adhesive tape and the joining partner connected to it, both under the conditions defined in DIN EN 1939 and in application—for example in the construction industry. This adhesive strength enables a permanent use and load of the joint.

Preferably, the pressure-sensitive adhesive tape produced by the method described above has a shear strength according to FTM 8 (100 mm², 0.5 kg) of at least 5 min, preferably at least 6 min, in particular preferably at least 7 min. This shear strength ensures that the adhesive bond is maintained even if shear forces occur.

The pressure-sensitive adhesive tape produced by the method described above preferably has a static peel strength according to DIN 4108-11 (625 mm², 30° C., 0.3 N) of at least 10 hours, preferably at least 12 hours, in particular preferably at least 14 hours. This ensures that, for a given width, the strength of the adhesive bond is sufficient to meet the requirements, for example in the construction sector, even under loads.

Preferably, the web-like substrate used has a specific weight per unit area of 20-180 g/m², preferably 30-150 g/m², more preferably 40-130 g/m². For these materials, the above mentioned weight per unit areas have shown the best results in terms of the ratio of low weight to sufficient strength, for example for use in construction industry.

It is particularly preferred if a web-shaped substrate with a specific weight per unit area of 45-180 g/m², preferably 55-140 g/m², further preferably 60-120 g/m² is used as the carrier material, provided it is selected from a group comprising coated and uncoated, single-layer or multilayer plastic films, preferably PE, PP, EVA, a mixture of PE and PP, PO and EVA, PET, PU, TPU, TPE, PA, PVC, PI films or film (metal) composites, coated and uncoated papers or metal films. This weight per unit area ensures easy handling, good conformability and high flexibility on rough surfaces at low weight. In particular, the high flexibility and good conformability enable fast and uniform wetting of the in particular rough surface to be bonded. In addition, sufficient strength is ensured at this weight per unit area, for example for use in the construction industry.

If woven, knitted or non-woven fabrics, preferably comprising PE, PP, PET, acrylate or other (possibly natural) plastics and/or polymers are used, the specific weight per unit area can be selected from a further range, which preferably extends from 10-180 g/m², further preferably from 20-120 g/m², in particular preferably from 30-90 g/m².

Preferably, the pressure-sensitive adhesive tape comprises at least one additional reinforcing layer. Such a (reinforcing) layer is preferably laminated into the pressure-sensitive adhesive composition. This (reinforcing) layer is preferably selected from a group comprising scrims, knitted fabrics, woven fabrics, tulle, non-woven fabrics and/or long-fibre paper. Preferably, the reinforcing layer has a specific weight per unit area of 2-140 g/m², preferably 4-130 g/^{m2}, further preferably 5-120 g/m². As further materials for reinforcement, materials have proved to be advantageous which are preferably selected from a group comprising plastic fibres (in particular PE, PP, PET, acrylate), glass fibres, carbon fibres, metal fibres, cotton fibres, cellulose fibres, protein fibres, wood fibres, abacá-fibres or materials made of further (possibly natural) plastics and/or polymers.

In another preferred embodiment, the pressure-sensitive adhesive tape does not comprise an additional reinforcing layer.

In a preferred method variant, a release liner is applied to the pressure-sensitive adhesive composition. This release liner is preferably selected from a group comprising papers coated on one or both sides, uncoated or plastic films coated on one or both sides, wherein the latter preferably being PE, PP or PET films, and has two opposing surfaces which, in a particularly preferred variant, have different adhesive properties with respect to the pressure-sensitive adhesive composition. These different properties are achieved by surface treatment (e.g. siliconisation) or by a release coating. Such a release liner is easy to handle and to separate before using the pressure-sensitive adhesive tape produced by this method. As an alternative to a release liner with different adhesive properties on the opposing surfaces, release liners coated on both sides with identical coatings on the opposing surfaces are also possible.

In a further preferred method variant, the pressure-sensitive adhesive composition is not applied with a release liner. In this case, the (back) side of the web-shaped substrate facing away from the pressure-sensitive adhesive composition has surface properties that allow the pressure-sensitive adhesive composition to be (easily) separated from this (back) side of the web-shaped substrate when the pressure-sensitive adhesive tape is wound as a roll or stacked in sections.

The present method makes it possible in a particularly simple way to modify the properties of the pressure-sensitive adhesive tape and in particular of the pressure-sensitive adhesive composition. Preferably, this can be adjusted by changing the coating speed and/or the exposure time. In the present method, a slower coating speed and/or longer exposure time results in a more cohesive and less adhesive glue. This makes it very easy to adjust the pressure-sensitive adhesive properties of the resulting adhesive tapes to the respective requirements. Thus, it is very easy to produce both very cohesive and less adhesive tapes for removable bondings and less cohesive and very adhesive tapes for permanent bonding.

Alternatively or supplementary to this, an adjustment of the above-mentioned properties of the pressure-sensitive adhesive tape and in particular of the pressure-sensitive adhesive composition is possible by changing the radiation intensity.

Furthermore, the invention is directed to an apparatus for producing pressure-sensitive adhesive tapes, which comprises a reservoir and a transport device for a web-shaped substrate, a reservoir and a transport device for a pressure-sensitive adhesive composition and/or a precursor for a pressure-sensitive adhesive composition, which contains at least one polymerisable and/or crosslinkable (meth-)acrylate monomer, (meth)acrylate oligomer and/or (meth)acrylate polymer and at least one polymerisation initiator, and a first device by means of which the pressure-sensitive adhesive composition and/or the precursor with a solvent content of <5% by weight, based on the total mass of the pressure-sensitive adhesive composition, is applied on one or both sides of the web-shaped substrate, and is further characterised in that at least one second device is arranged along the transport path with respect to the first application device, wherein the second device being an emitter for electromagnetic radiation of a predetermined wavelength, electrons or accelerated ions, by means of which the polymerisation initiator can be activated in such a way that polymerisation of the pressure-sensitive adhesive composition and/or of a precursor can be triggered by acting upon with electromagnetic radiation.

Preferably, the apparatus has a pressurisation device through which reaction heat from the polymerisation/cross-linking of the pressure-sensitive adhesive composition can be dissipated by means of a cool inert gas flow.

In addition or alternatively to this, there could be at least one transport roller with cooling medium flowing through or around it. Such a transport roller with cooling medium flowing through it would have the advantage that the pressure-sensitive adhesive composition does not come into direct contact with the cooling medium. Thus, a reaction between the pressure-sensitive adhesive composition and the cooling medium can be avoided and/or the dissolution of components of the pressure-sensitive adhesive composition by the cooling medium can be avoided.

Alternatively, or in addition to this, cooling can also be carried out by contact cooling, for example by cooling the bottom of the transport channel on which the web-shaped substrate runs during transport.

Preferably, the apparatus has a reaction chamber which contains an inert medium. In particular, media that do not react with the pressure-sensitive adhesive, its precursor and/or the radiation or particles emitted by the emitter are advantageous as an inert medium. For example, the inert medium could be an inert gas such as a noble gas or molecular nitrogen (N₂). It is advantageous for polymerisation that the entire transport channel is completely inert. This can be checked, for example, by means of oxygen sensors. In a preferred variant, the inert gas can also serve as a cooling medium.

In a preferred embodiment, such a reaction chamber is formed by a housing which is preferably rigid, at least in sections, and which is preferably closed on all sides during operation, but has at least one inlet region and one outlet region through which the web-shaped substrate, the pressure-sensitive adhesive composition, optionally auxiliary materials and/or the inert medium can be guided into the reaction chamber or out of it. Preferably, these inlet or outlet regions are designed in such a way that the outflow of the inert medium from the reaction chamber is prevented or at least reduced during the passage of the inlet or outlet region through the other material(s). Corresponding means are known from the prior art.

In a preferred embodiment, the reaction chamber has a flexible boundary at least in sections, preferably at least along a plane formed by the web-shaped substrate or a plane parallel thereto. Such a flexible boundary could be, for example, a single- or multi-layer film, membrane or the like.

Preferably, such a reaction chamber has a flexible boundary on at least 2, preferably at least 3, further preferably at least 4 and in particular preferably at least 5 sides. Possible designs of the clean room have already been described above on the method side. These designs are also advantageous on the apparatus side.

Preferably, a pressure difference between the inert gas pressure and the ambient pressure is permanently maintained in order to prevent ambient air from flowing into the reaction chamber. Preferably, the apparatus therefore has measuring devices for the ambient pressure and the internal pressure in the reaction chamber as well as means for adjusting a pressure difference. An advantageous minimum pressure difference with respect to the ambient pressure is at least 1 Pa, preferably at least 2 Pa, preferably at least 5 Pa, further preferably at least 10 Pa, further preferably at least 20 Pa and in particular preferably at least 50 Pa.

Preferably, the apparatus has a temperature control device by means of which the pressure-sensitive adhesive composition can be brought to a temperature between 0 and 30° C., preferably between 15 and 25° C., particularly preferably to room temperature of about 20° C., before being applied to the web-shaped substrate.

Optionally, in addition or alternatively, a temperature control device is provided by means of which the pressure-sensitive adhesive composition can be kept in one of the above-mentioned temperature ranges during polymerisation under an inert gas atmosphere.

The invention also relates to a pressure-sensitive adhesive tape having a pressure-sensitive adhesive composition which has a solvent content of <5% by weight, based on the total mass of the pressure-sensitive adhesive composition, wherein the pressure-sensitive adhesive composition comprising secondary products of a free-radical polymerisation, induced by electromagnetic radiation of a predetermined wavelength, electrons or accelerated ions, of a polymerisable (meth)acrylate monomer and/or (meth)-acrylate oligomer on a web-shaped substrate.

Preferably, such a pressure-sensitive adhesive tape is a technical adhesive tape for use in the construction industry.

In particular, it is preferred that the pressure-sensitive adhesive tape is produced by one of the methods described above.

Preferably, the pressure-sensitive adhesive tape comprises a pressure-sensitive adhesive composition with an application weight of 70-300 g/m², in particular preferably 150-270-g/m². These application weights enable by this pressure-sensitive adhesive tape a particularly well and quick wetting of the often rough surfaces (in particular in applications in the construction industry) and thus to achieve great initial adhesion and fast final adhesion.

In an advantageous embodiment, the pressure-sensitive adhesive tape has an initial adhesion according to FTM 9 to steel of at least 6 N/cm, preferably ≥8 N/cm, particularly preferably 9 N/cm, in particular preferably ≥10 N/cm. This initial adhesion enables excellent bonds between the pressure-sensitive adhesive tape and the joining partner connected thereto, both under the conditions defined in FTM 9 and in application, for example in the construction industry. This initial adhesion allows immediate use and loading of the bond.

In an advantageous embodiment, the pressure-sensitive adhesive tape has a bond strength to steel according to DIN EN 1939 of at least 6 N/cm, preferably ≥7 N/cm, particularly preferably ≥8 N/cm. This adhesive strength enables excellent bonds between the pressure-sensitive adhesive tape and the joining partner connected thereto both under the conditions defined in DIN EN 1939 and in application, for example in the construction industry. This adhesive strength enables a permanent use and load of the joint.

Preferably, the pressure-sensitive adhesive tape has a shear strength according to FTM 8 (100 mm², 0.5 kg) of at least 5 min, preferably at least 6 min, in particular preferably at least 7 min. This shear strength ensures that the adhesive bond is maintained even if shear forces occur.

Preferably, the pressure-sensitive adhesive tape has a static peel strength according to DIN 4108-11 (625 mm², 30° C., 0.3 N) of at least 10 hours, preferably at least 12 hours, in particular preferably at least 14 hours. This ensures that, for a given width of the pressure-sensitive adhesive tape, it also offers the necessary strength of the adhesive bond under loads in order to meet the requirements that exist, for example, in the construction sector.

As already described above on the method side, it is preferred that the web-shaped substrate is selected from a group comprising coated and uncoated, single-layer or multi-layer plastic films, preferably PE, PP, EVA, a mixture of PE and PP, PO and EVA, PET, PU, TPU, TPE, PA, PVC, PI films or film (metal) laminates, coated and uncoated papers, nonwovens, fabrics, (siliconised) metal films, papers siliconised on one or both sides and plastic films siliconised on one or both sides, preferably PE, PP or PET films. These materials have shown that they are particularly well suited to meet the durability, strength and mechanical and chemical resilience requirements demanded in the construction industry, as well as to withstand the radiation exposure that occurs during radiation-induced polymerisation.

The pressure sensitive adhesive tape preferably comprises at least one additional layer comprising scrims, knitted fabrics, woven fabrics, tulle, non-woven fabrics and/or long fibre paper, which are preferably selected from a group comprising cotton fibres, cellulose fibres, protein fibres, plastic fibres, glass fibres, carbon fibres and metal fibres. Such reinforcement may be integrated into the web-shaped substrate or bonded to the web-shaped substrate. The former is conceivable, for example, in the case of web-shaped substrates made of PO or PET or aluminium, in which, for example, a scrim or the like is embedded in the web-shaped substrate, for example by means of PO melt. However, it is in particular preferred that the additional (reinforcing) layer is bonded (e.g. glued) to the web-shaped substrate by means of the pressure-sensitive adhesive composition. It is particularly preferred that this layer is embedded in the pressure-sensitive adhesive composition. It can be arranged on the side of the pressure-sensitive adhesive composition facing the web-shaped substrate, on the side of the pressure-sensitive adhesive composition facing away from the web-shaped substrate and/or in a central region of the pressure-sensitive adhesive composition, e.g. between different pressure-sensitive adhesive layers.

In an alternative, also preferred variant, the pressure-sensitive adhesive tape does not comprise an additional layer. This is in particular preferred if the web-shaped substrate already has sufficient strength in combination with the pressure-sensitive adhesive composition and thus an additional reinforcing layer as described above can be dispensed with.

Preferably, the web-shaped substrate has a specific weight per unit area of 20-180 g/m², preferably 30-150 g/m², further preferably 40-130 g/m². This weight per unit area ensures easier handling, good conformability and high flexibility on rough surfaces at low weight. In particular, the high flexibility and good conformability enable fast and uniform wetting of the in particular rough surface to be bonded. In addition, sufficient strength is ensured at this weight for unit area, for example for use in the construction industry.

It is particularly preferred that the web-shaped substrate has a specific weight per unit area of 45-180 g/m², preferably 55-140 g/m², further preferably 60-120 g/m², provided that it is selected from a group comprising coated and uncoated, single-layer or multi-layer plastic films, preferably PE, PP, EVA, a mixture of PE and PP, PO and EVA, PET, PU, TPU, TPE, PA, PVC, PI films or film (metal) laminates, coated and uncoated papers or metal films. For these materials, the weights per unit area mentioned above have shown the best results in terms of the ratio of low weight to sufficient strength, for example for use in construction industry.

If, for example, woven, knitted or non-woven fabrics, preferably comprising PE, PP, PET, acrylate or further (possibly natural) plastics and/or polymers, are used as the web-shaped substrate, the specific weight per unit area can be selected from a further range which preferably extends from 10-180 g/m², further preferably from 20-120 g/m², in particular preferably from 30-90 g/m².

Preferably, the web-shaped substrate comprises a laminated additional reinforcement. This is preferably selected from a group comprising scrims, knitted fabrics, woven fabrics, tulle, nonwovens and/or long-fibre paper. As materials for this purpose, materials have proven to be advantageous which are preferably selected from a group comprising plastic fibres (in particular PE, PP, PET, acrylate), glass fibres, carbon fibres, metal fibres, cotton fibres, cellulose fibres, protein fibres, abacá-fibres or materials made from further (possibly natural) plastics and/or polymers.

In an alternative, also preferred variant, the web-shaped substrate does not comprise any additional reinforcement. This is particularly preferred if the web-shaped substrate already has sufficient strength and thus an additional reinforcing layer as described above can be dispensed with.

Preferably, the pressure-sensitive adhesive tape comprises a release liner. This preferably has an adhesion to the pressure-sensitive adhesive composition on at least one side that is lower than the adhesion between the pressure-sensitive adhesive composition and the carrier material. This could be ensured, for example, by a surface coating on one or both sides (e.g. siliconisation, release coat) or by surface treatment (e.g. acting upon with electrons or ions, adhesion promoter). Preferably, the release liner is a paper or a plastic film, wherein the latter preferably being a PE, PP or PET film. In particular, it is preferably a paper siliconised on one or both sides or a plastic film siliconised on one or both sides.

In an alternative, also preferred variant, the pressure-sensitive adhesive tape does not comprise a release liner. This enables particularly easy handling and avoids waste due to the absence of the release liner to be removed before use, which is particularly advantageous in the construction sector.

An exemplary formulation as a precursor to a pressure-sensitive adhesive composition comprises 40 kg of 2-ethylhexyl acrylate, 25 kg of n-butyl acrylate, 15 kg of acrylic acid and 2 kg of butanediol diacrylate. This is purged with inert gas and then mixed with a mixture of 4 kg 2,2-dimethoxy-1,2-diphenylethan-1-one in 14 kg 2-ethylhexyl acrylate. After sufficient inerting, which is ensured for example by checking the oxygen content (<1%), this adhesive raw mixture is fed to the coating plant. There it is applied to a single- or double-sided siliconised PET film with a basis weight of 30 g/m². The coating weight is, for example, 70 g/m². The coating speed can be adjusted depending on the desired adhesive properties and is, for example, 10 metres per minute. The radical polymerisation is initiated by irradiation with UVA light. This takes place in a transport channel. The resulting adhesive tape with the crosslinked pressure-sensitive adhesive coating is removed from the transport channel and wound into a roll.

A further exemplary formulation as a precursor to a pressure-sensitive adhesive composition comprises 20 kg of 2-ethylhexyl acrylate, 45 kg of n-butyl acrylate, 10 kg of acrylic acid, 3 kg of hexanediol diacrylate and 10 kg of a hydrocarbon resin. This is purged with inert gas and then a mixture of 2 kg 2,2-dimethoxy-1,2-diphenylethan-1-one in 10 kg 2-ethylhexyl acrylate is added. After sufficient inerting, which is ensured for example by checking the oxygen content (<1%), this adhesive raw mixture is fed to the coating plant. There it is applied to a single- or double-sided siliconised paper with a weight per unit area of 90 g/m². The coating weight is, for example, 120 g/m². The coating speed can be adjusted depending on the desired adhesive properties and is, for example, 8 metres per minute. The radical polymerisation is initiated in the transport channel by irradiation with UV-A light. The resulting adhesive tape with the cross-linked pressure-sensitive adhesive coating is removed from the transport channel and wound into a roll.

1. Method for the manufacture of pressure sensitive adhesive tape, comprising:
providing a web-shaped substrate,
providing a polymerisable pressure-sensitive adhesive composition and/or a precursor for a pressure-sensitive adhesive composition, wherein the pressure-sensitive adhesive composition and/or the precursor for a pressure-sensitive adhesive composition containing at least one polymerisable (meth-)acrylate monomer and/or (meth-)acrylate oligomer and/or (meth-)acrylate polymer and at least one polymerisation initiator and having a solvent content of <5% by weight, based on the total mass of the pressure-sensitive adhesive composition,
application of the pressure-sensitive adhesive composition and/or its precursor to one or both sides of at least sections of the web-shaped substrate,
transport of a web-shaped substrate to which the pressure-sensitive adhesive composition and/or its precursor has been applied along a predetermined transport path, wherein the transport path running at least in sections in the region of influence of an emitter for electromagnetic radiation, electrons or accelerated ions,
activation of the polymerisation initiator by acting upon with electromagnetic radiation, electrons or accelerated ions during the transport of the web-shaped substrate along the predetermined transport path and
polymerisation of the pressure sensitive adhesive composition and/or the precursor for a pressure sensitive adhesive composition on the web-shaped substrate during transport thereof.

2. The method according to claim 1, wherein
the polymerisable pressure-sensitive adhesive composition and/or the precursor for a pressure-sensitive adhesive composition comprises monomers and/or oligomers which are crosslinkable and/or capable of forming crosslinks between polymers and optionally additionally at least one crosslinker, wherein the crosslinker being selected such that it cannot be activated by acting upon with electromagnetic radiation, electrons or accelerated ions during activation of the polymerisation initiator.

3. The method of producing pressure sensitive adhesive tapes according to claim 1, wherein
the polymerisable and optionally also crosslinkable pressure-sensitive adhesive composition and/or its precursor is solvent-free.

4. The method for the preparation of pressure sensitive adhesive tapes according to claim 1, wherein
the photoinitiator is selected from a group comprising benzophenones, benzil derivatives, benzoin derivatives, dialkoxyacetophenones, phosphine oxides, phosphinic acid esters and hydroxyalkylphenones and is added to the pressure-sensitive adhesive composition in a proportion of 0-10, preferably 0.01-5, particularly preferably 0.05-2% by weight, based on the mass of the total pressure-sensitive adhesive composition.

5. The method for producing pressure sensitive adhesive tapes according to claim 2, wherein
the crosslinker is selected from a group comprising aziridines, polycarbodiimides, epoxides, amino resins, peroxides, triazines, isocyanates, organofunctional silanes, propyleneimines, ethyleneimines, metal acid esters, metal chelates and metal salts and is added to the pressure-sensitive adhesive composition in a proportion of 0-10, preferably 0.01-5, particularly preferably 0.01-2% by weight, based on the mass of the total pressure-sensitive adhesive composition.

6. The method of producing pressure sensitive adhesive tapes according to claim 2, wherein
the polymerisable and optionally also crosslinkable pressure-sensitive adhesive composition and/or its precursor comprises at least one resin, wherein this being selected from a group comprising hydrocarbon resins and unsaturated polyester resins, in particular terpene resins, terpene phenol resins, acrylate resins, urethane resins, melamine resins and natural resins, and is added to the pressure-sensitive adhesive composition in a proportion of up to 50%, preferably up to 30%, particularly preferably up to 20% by weight, based on the mass of the total pressure-sensitive adhesive composition.

7. The method of producing pressure sensitive adhesive tapes according to claim 1, wherein
the polymerisable and optionally also crosslinkable pressure-sensitive adhesive composition and/or its precursor is resin-free.

8. The method for producing pressure-sensitive adhesive tapes according to claim 1, wherein
the pressure-sensitive adhesive composition and/or its precursor is applied to the web-like substrate with an application weight of 1-5000 g/m², preferably 5-4000 g/m².

9. The method of producing pressure sensitive adhesive tapes according to claim 1, wherein
the pressure-sensitive adhesive composition and/or its precursor has a solvent content of <5% by weight relative to the total composition, preferably 3% by weight relative to the total composition, particularly preferably <1% by weight relative to the total composition, and is particularly preferably solvent-free.

10. The method of producing pressure sensitive adhesive tapes according to claim 1, wherein
the web-shaped substrate is selected from a group comprising coated and uncoated, single-layer or multilayer plastic films, preferably PE, PP, EVA, a mixture of PE and PP, PO and EVA, PET, PU, TPU, TPE, PA, PVC, PI films or film (metal) laminates, coated and uncoated papers, nonwovens, fabrics, (siliconised) metal films, papers siliconised on one or both sides and plastic films siliconised on one or both sides, preferably PE, PP or PET films, and optionally a layer comprising fibres, scrims, knitted fabrics, woven fabrics, tulle, non-woven fabrics and/or long-fibre paper is provided, which are preferably selected from a group comprising plastic fibres (in particular PE, PP, PET, acrylate), glass fibres, carbon fibres, metal fibres, cotton fibres, cellulose fibres, protein fibres, abaca-fibres or materials made from further (optionally natural) plastics and/or polymers.

11. Apparatus for producing pressure-sensitive adhesive tapes comprising a reservoir and a transport device for a web-shaped substrate, a reservoir and a transport device for a pressure-sensitive adhesive composition and/or its precursor, wherein the pressure-sensitive adhesive composition and/or the precursor for a pressure-sensitive adhesive composition contains at least one polymerisable and optionally additionally crosslinkable (meth-)acrylate monomer and/or (meth-)acrylate oligomer and/or (meth)acrylate polymer and at least one polymerisation initiator and a first application device by means of which the pressure-sensitive adhesive composition and/or its precursor is applied with a solvent content of <5% by weight, based on the total mass of the pressure-sensitive adhesive composition, can be applied to one or both sides of the web-shaped substrate,
wherein at least one emitter for electromagnetic radiation of a predetermined wavelength, electrons or accelerated ions, by means of which the polymerisation initiator can be activated, is arranged along the transport path downstream with respect to the first application device.

12. The apparatus according to claim 11, wherein
the apparatus has a pressurisation device through which reaction heat from the polymerisation of the pressure-sensitive adhesive composition can be dissipated by means of a cool inert gas stream, and preferably at least one transport roller through which or around which cooling medium flows and/or the bottom of the transport channel on which the web-shaped substrate runs during transport has a cooling device through which the web-shaped substrate can be cooled, preferably by contact cooling.

13. The apparatus according to claim 11, wherein
the apparatus has a temperature control device by means of which the pressure-sensitive adhesive composition can be brought to a temperature between 0 and 30° C., preferably between 15 and 25° C., particularly preferably to room temperature of about 20° C., before being applied to the web-shaped substrate and, further preferably, can be kept at this temperature during polymerisation in an inert gas atmosphere.

14. Pressure-sensitive adhesive tape having a pressure-sensitive adhesive composition which has a solvent content of <5% by weight, based on the total mass of the pressure-sensitive adhesive composition,
wherein the pressure-sensitive adhesive composition comprises secondary products of a free-radical polymerisation, induced by electromagnetic radiation of a predetermined wavelength, electrons or accelerated ions, of a polymerisable (meth)acrylate monomer and/or (meth-)acrylate oligomer on a web-shaped substrate and is preferably produced by a method according to claim 1.
